(19) United States
(12) Patent Application Publication
(10) Pub. No.: US 2022/0091654 A1
(43) Pub. Date: Mar. 24, 2022

(54) DEVICE OPERATION MODIFICATIONS BASED ON MONITORED POWER LEVELS

(71) Applicant: Hewlett-Packard Development Company, L.P., Spring, TX (US)

(72) Inventors: Fangyong Dai, Spring, TX (US); Peter Siyuan Zhang, Spring, TX (US); Qijun Chen, Spring, TX (US)

(73) Assignee: Hewlett-Packard Development Company, L.P., Spring, TX (US)

(21) Appl. No.: 17/298,561

(22) PCT Filed: Jun. 7, 2019
(86) PCT No.: PCT/US2019/036025

§ 371 Date: May 29, 2021

(51) Int. Cl. G06F 1/3206; G06F 1/20; G06F 11/30

(52) U.S. Cl. CPC G06F 1/3206; G06F 11/3024; G06F 11/3058; G06F 1/206

(57) ABSTRACT

An example apparatus includes a power monitor, a memory, and a processor. The power monitor is to measure a power level of the apparatus. The memory is to store a power level to temperature increase rate correlation. The processor is in communication with the power monitor and the memory. The processor is to determine that an internal temperature threshold is to be exceeded based on the power level and the power level to temperature increase rate correlation. The processor also is to perform a device operation modification to reduce the power level in response to a determination that the internal temperature threshold is to be exceeded.

### BACKGROUND

Computing devices may be installed with various peripheral devices and be used to execute various applications. When the computing device executes a number of applications, the applications may cause a proportion of energy inflow into the processor, which may cause the processor to generate heat as the processor operates. In addition, the computing device may activate certain peripheral devices associated with some of the applications. The peripheral devices can also generate heat.

### BRIEF DESCRIPTION OF THE DRAWINGS

FIG. 1 is a block diagram of an example apparatus that includes a device temperature management control based on monitored power levels of the present disclosure;

FIG. 2 is a more detailed block diagram of the device temperature management control of the present disclosure;

FIG. 3 illustrates an example of a pre-defined power to temperature rate graph of the present disclosure;

FIG. 4 is a block diagram of an example non-transitory computer readable storage medium storing instructions executed by a processor to modify operation of a device based on a monitored power level of the present disclosure; and

FIG. 5 is a block diagram of another example non-transitory computer readable storage medium storing instructions executed by a processor to modify operation of a device based on a monitored power level of the present disclosure.

### DETAILED DESCRIPTION

Active applications may cause various devices within a computing device to consume power and generate heat. For example, a processor may generate heat when overloaded to execute too many applications simultaneously. Peripheral devices (e.g., graphics processors, internal hard drives, various ports and interface cards, communication devices, and the like) within the computing device may also generate heat when turned on or activated by applications.

When heat is generated inside of the computing device, the internal temperature of the computing device may rise. High temperatures within the computing device may cause the computing device to malfunction or operate inefficiently.

In some instances, an internal fan may be turned on when an internal temperature is too high to try to reduce the internal temperature of the computing device. However, the fan may be ineffective when the temperature of the computing device has already reached a high level. Alternatively, the computing device may operate inefficiently for a long period of time as the fan may take a long time to eventually reduce the temperature of the computing device.

Examples herein provide an approach to predict a temperature of a computing device at a future time based on monitored power levels. For example, the computing device may store a pre-defined chart or graph that correlates power levels to a temperature increase rate. Based on the graph and a monitored power level, the computing device may predict that if a current level of power consumption continues, the computing device may breach, or exceed, an internal temperature threshold at a future time.

In response, the computing device may execute a device operation modification. The device operation modification may reduce power levels of the computing device to reduce the temperature increase rate, and thereby prevent the internal temperature threshold from being exceeded. By predicting a possible future breach of the internal temperature threshold, the computing device may execute a more gradual modification or temperature control (e.g., as opposed to an abrupt activation of a fan or suddenly freezing an application that is being executed) that may be less noticeable to the user operating the computing device. Thus, the temperature control of the present disclosure may provide a more enjoyable user experience on the computing device.

In addition, the device or devices that are modified may be defined based on a user preference. For example, the user may select a preference such as efficient temperature control or quiet temperature control. Based on the user preferences, the temperature control may be performed by maximizing the use of the fan to allow the processor and other devices to run at maximum capacity or by preventing the fan from operating to maintain a quiet operation of the computing device.

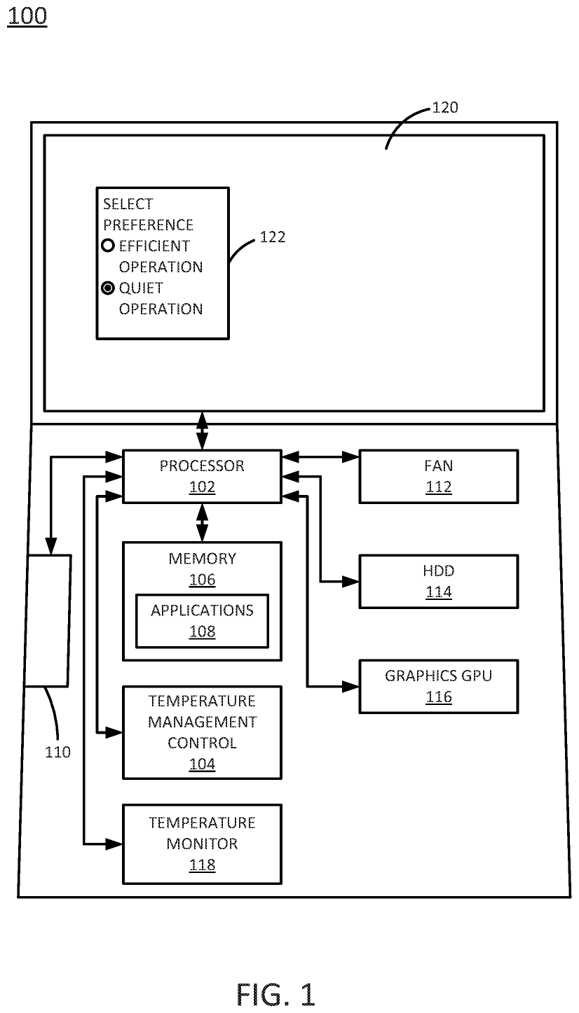

FIG. 1 illustrates a diagram of an example apparatus 100 that includes a temperature management control 104 to modify operations of the apparatus 100 based on monitored power levels of the present disclosure. In one example, the apparatus 100 may be a computing device such as a laptop computer, a desktop computer, a tablet computer, and the like.

The apparatus 100 may include a processor 102 that is communicatively coupled to a memory 106, the temperature management control 104, a plurality devices 110, 112, 114, and 116, a temperature monitor 118, and a display 120. The plurality of devices 110, 112, 114, and 116 may be various different peripheral devices or components of the apparatus 100. For example, the device 110 may be a bus of various interfaces or ports. The device 112 may be a fan. The device 114 may be a storage device (e.g., a powered hard disk drive, a solid state drive, and the like). The device 116 may be graphics processor (GPU). Although a few examples of devices are illustrated in FIG. 1, it should be noted that the apparatus 100 may include other devices that are not shown.

In one example, the temperature monitor 118 may be any type of temperature sensor such as a thermometer or a thermocouple that can measure the internal temperature of the apparatus 100. The internal temperature measured by the temperature monitor 118 may be fed to the processor 102 and used by the temperature management control 104 to regulate the internal temperature of the apparatus 100, as discussed below.

In one example, the memory 106 may be a non-transitory computer readable medium. The memory 106 may be part of the HDD 114, random access memory (RAM), read only memory (ROM), a solid state drive, and the like. The memory 106 may store applications 108. The applications 108 may include various instructions or programs that may be executed by the processor 102.

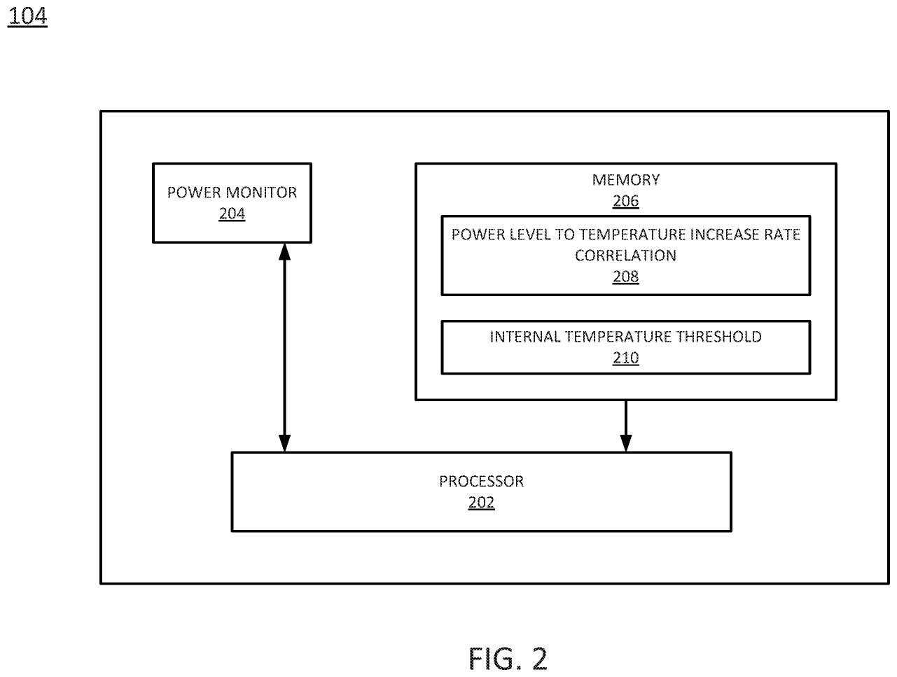

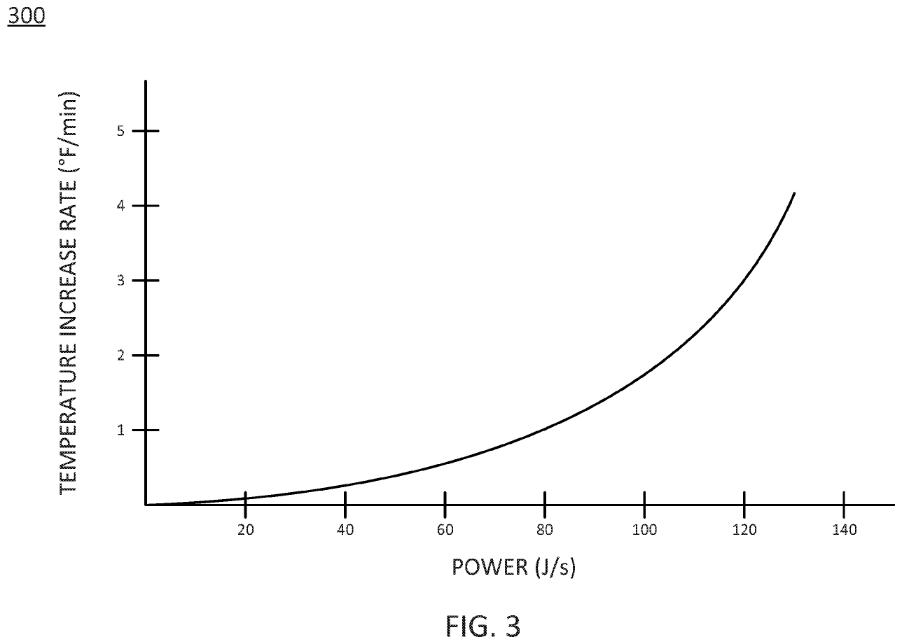

In one example, the temperature management control 104 may monitor a power level of the apparatus. The power level may be correlated to a temperature increase rate based on a temperature increase rate correlation that is illustrated in FIGS. 2 and 3 and discussed in further details below. Based on the temperature increase rate at a measured power level, the temperature management control 104 may determine when an internal temperature threshold will be exceeded.

A benefit of early determination is that, rather than abruptly turning on the fan 112 to try to cool the internal temperature of the apparatus 100, the temperature management control 104 may perform gradual temperature controls to help keep the internal temperature below the internal temperature threshold.

FIG. 2 illustrates a detailed block diagram of the temperature management control 104. In one example, the temperature management control 104 may include a processor 202, a power monitor 204, and a memory 206. In one example, the processor 202 may be communicatively coupled to the power monitor 204 and the memory 206. The processor 202 may be the same as the processor 102 of FIG. 1 or may be a separate processor, controller, or application specific integrated controller (ASIC) that is dedicated to the operation of the temperature management control 104.

In one example, the power monitor 204 may be implemented as a circuit. For example, a combination of resistors and an energy meter may be coupled to each device 110, 112, 114, and 116 and/or to the processor 102 to measure the amount of power based on the amount of current across the resistor and an input voltage. In one example, the power monitor 204 may measure an amount of power consumed by the devices 110, 112, 114, and 116 and/or by the processor 102.

In one example, the power level may be an average power level measured within a time window (e.g., the last 30 seconds). The average power level can be used as the power level can be volatile and vary moment to moment. Using the average power level may smooth the volatility associated with power levels. The average power level may be also referred to as an energy inflow rate that can be measured in Joules per second.

In one example, the power monitor 204 may be deployed as a monitoring application that is executed by the processor 202. For example, each application 108 that is executing on the apparatus 100 may report the devices (e.g., devices 110, 112, 114, and 116) used to execute the application 108. In addition, the processor 102 may report the amount of processing resources allocated to each application 108. The amount of processing resources may be correlated to an amount of power consumed by the processor 102.

In one example, the power monitor 204 may be deployed as a combination of circuitry and as an application. For example, the power levels of the devices 110, 112, 114, and 116 may be monitored via dedicated circuits using resistors as described above. The amount of processing resources allocated to applications 108 may be reported to the processor 202 via a reporting application.

In one example, the memory 206 may be a non-transitory computer readable medium. The memory 206 may be the same as the memory 106 of FIG. 1 (e.g., a part of the memory 106 or a partitioned portion of the memory 106) or may be a separate dedicated memory for the temperature management control 104.

In one example, the memory 206 may store a correlation 208 between power level and temperature increase rate, and an internal temperature threshold 210. The correlation 208 and the internal temperature threshold 210 may be established after the apparatus 100 is manufactured and before the apparatus 100 is sold. The internal temperature threshold 210 may be associated with a temperature where the operation of the apparatus 100 is reduced below a desirable level (e.g. the processor operates at a clock speed below a threshold) or begins to malfunction (e.g., the processor temperature exceeds its operational specification and applications begin to freeze).

For example, the apparatus 100 may be operated under various different power loads and the temperature increase rate may be measured at the different power loads. The power level to temperature increase rate correlation 208 may provide information related to how quickly the internal temperature of the apparatus 100 may rise as the power level increases. The power levels may be increased to increase the internal temperature until the apparatus begins to operate below the desirable level or to malfunction to determine the internal temperature threshold 210.

The power level to temperature increase rate correlation 208 may be different for different computing devices. In one example, the power level to temperature increase rate correlation 208 may be the same for devices that have the same configuration (e.g., the same applications, same devices, same processor, same housing, same heat sinks, and the like).

FIG. 3 illustrates an example graph 300 of the power level temperature increase rate correlation 208. It should be noted that the values and units illustrated in FIG. 3 for the graph 300 are provided as examples and that other values may be used depending on the acceptable power levels and measured temperature increase rates for a particular apparatus or computing device.

In one example, the graph 300 may illustrate a graph of power versus temperature increase rate. In one example, the power levels may be measured in joules per minute (as shown in FIG. 3) or in joules per second, and the temperature increase rate may be measured in degrees Fahrenheit per minute (° F./min). In one example, the correlation between the power and the temperature increase rate may be exponential. In other words, as the power level increases, the temperature increase rate may begin to rise faster.

The temperature management control 104 may use the power level to temperature increase rate correlation 208 to convert a current power level into a temperature increase rate. For example, if the apparatus 100 is consuming approximately 100 joules per minute of power, the temperature increase rate may be 2° F./min. The temperature monitor 118 may measure the current internal temperature to be 85° F. The internal temperature threshold may be 130° F. Thus, based on the current power consumption, the temperature management control 104 may determine that the internal temperature threshold may be breached in 23 minutes if the apparatus 100 continues to operate at the current power level.

Rather than waiting until the internal temperature threshold is breached and the apparatus 100 begins to malfunction, close applications, and the like, the temperature management control 104 may modify device operations before the internal temperature threshold is breached. The temperature management control 104 may perform a more gradual approach to internal temperature control such that the user is provided with a better experience with the apparatus 100.

An example of the operation of the temperature management control 104 may be described below by referring to both FIGS. 1 and 2. The values provided in the example are based on the example graph 300 illustrated in FIG. 3. However, it should be noted that the values used in the example are not intended to necessarily reflect actual power consumption levels of a computing device, or real temperature increase rates, and are provided as examples.

In one example, the processor 202 may monitor and calculate an amount of power consumed by the apparatus 100. In one example, each active application of the applications 108 may consume some power that may be proportional to an amount of processing resources that are allocated, and may cause various devices to be activated in association with the active applications. The amount of power consumed by the processor 102 and each device 110, 112, 114, and 116 may be totaled to calculate the power level consumed by the apparatus 100.

The processor 202 may then modify operation (e.g., throttle an application, suspend an application, reduce a number of processing threads, deactivate a device, stop a particular port, and the like) of the processor 102 and/or devices 110, 112, 114, and 116 to reduce the overall power level. The operation of the processor 102 and/or devices 110, 112, 114, and 116 may be modified in response to suspending or throttling an application that may be consuming too much power. The processor 202 may then compare the power level to the power level to temperature increase rate correlation 208 to determine an updated temperature increase rate.

In one example, the processor 202 may attempt to reduce the temperature increase rate below a threshold rate (e.g., less than 1° F./min) by reducing the power level by 40 joules/minute. Said another way, the processor 202 may attempt to reduce the temperature increase rate such that the internal temperature is not expected to exceed the internal temperature threshold 210, or that the temperature increase rate is so low that the internal temperature would not exceed the internal temperature threshold 210 for a long period of time (e.g., 2 hours, 4 hours, and the like).

In one example, the processor 202 may analyze the applications 108 that are being executed and an amount of power consumed by each application 108. For example, a portion of power consumed by the processor 102 may be attributed to an application 108 based on a percentage of the processing resources used by the application 108. In addition, the application 108 may use the storage device 114 and the graphical processing unit 116. The processor 202 may determine that the application 108 is consuming 40 joules/minute of power. As a result, the processor 202 may throttle or suspend the application 108 for the time being. As a result, the reduction in processor usage, deactivation of the storage device 114, and deactivation of the graphical processing unit 116 may reduce the power consumption by 40 joules/minute. The lower power level may be associated with a lower temperature increase rate to keep the internal temperature below the internal temperature threshold 210. The power level may be continually monitored. Similarly, the processor 202 may continually determine whether the application 108 can be resumed from the throttled or suspended state, or whether the internal temperature threshold 210 will be breached, as the power levels may fluctuate or change.

In one example, the applications 108 to be throttled or suspended may be modified based on a priority list. In one example, the priority list may be based on a descending order of power consumption. Applications that use a large amount of computing resources may cause the processor to run harder and hotter, thereby leading to higher temperature increase rates.

For example, the processor 202 may receive the power consumption information from the applications 108, as described above. The applications 108 may also be listed with an amount of computing resources (e.g., processor usage, memory usage, and the like) that is consumed by each of the applications 108. Thus, the list may order the applications 108 based on a sum of the power consumption calculated from active devices 110, 112, 114, and 116 to execute the applications 108 and an amount of processing resources allocated to execute the applications 108.

The processor 202 may then order the applications 108 based on the power consumption of the applications 108. Based on the order of power consumption, the processor 202 may begin selecting applications 108 to suspend or throttle one-by-one based on the highest amounts of power consumption. Suspending or throttling the applications 108 may modify operation of the processor 102 or devices 110, 112, 114, or 116 to reduce the overall power level.

In one example, the priority list may be defined by a user rather than the amount of power consumed by each device and/or application. For example, the user may select certain applications that are not to be throttled or suspended or devices that are not to be modified during operation. For example, the user may select a video application, the wireless radio to receive streaming data for the video application, and the processing resources allocated to the video application. As a result, if the internal temperature threshold 210 will be breached, the processor 202 may attempt to select other applications 108 to modify operation of devices (i.e., devices other than the wireless radio) and/or processor resources allocated to the other applications 108 to reduce the power level.

In one example, to avoid modifying operation of a device or application that a user is using, the processor 202 may provide the ordered list, as described above, to the user via the display 120. For example, the display 120 may include a graphical user interface (GUI) that notifies the user that the internal temperature is increasing at a rate that may negatively affect the performance of the apparatus 100. The notification may provide the list and ask the user to select the applications to suspend or throttle such that the operation of the associated devices can be modified to reduce the power level. The list may include the applications 108 that are being executed, an amount of power consumed by the applications 108, the devices used to execute the applications 108, the amount of processing resources allocated to the applications 108, and the like. As a result, the user may know which devices are associated with which applications and select the appropriate applications without affecting an application the user may be currently using.

In one example, the notification may indicate how much the power level should be reduced by (e.g., please reduce the power level by 20 joules/minute) so that the user knows how many applications to select based on the ordered list. As a result, the user may select the applications to be modified to avoid accidentally impacting an application or device the user is using.

In one example, the devices 110, 112, 114, and 116 and/or the applications 108 that are selected may be based on a temperature control management preference selected by the user. FIG. 1 illustrates an example of a user interface 122 that displays the temperature control management preference. For example, the preferences may include efficient operation or quiet operation. It should be noted that other preferences may be deployed and that the preferences may be labeled with similar or different names.

In one example, the efficient operation may select applications to suspend or throttle based on a highest power usage to maintain a highest level of performance. Thus, the applications that use the most amount of power may be selected to be suspended or throttled to modify operation of the associated devices 110, 112, 114, and 116 and/or the processor 102 such that the apparatus 100 reduces the internal temperature while maintaining a highest level of performance. In other words, the user may not care about noise level. Thus, the processor 202 may also activate the fan 112 to operate at a highest speed and close some applications 108 that may consume a low amount of power and that may not affect the performance of the apparatus 100.

In one example, the quiet operation may select the applications 108 that consume the most amount of power to reduce the power level without having to activate the fan 112. For example, the apparatus 100 may be in a library or a quiet environment with other individuals. The user may not want to disturb the other individuals and may select the quiet operation preference.

When the quiet operation is selected, the applications 108 that consume the highest amounts of power may be suspended or throttled to modify operation of a large number of the devices 110, 112, 114, or 116, thereby reducing the overall power level of the apparatus. As a result, the fan 112 may remain at a low acoustic fan speed or may be deactivated while reducing the internal temperature of the apparatus 100 for a quiet operation. In other words, the fan 112 may be turned on or modified to a high acoustic fan speed as a last resort.

In one example, the examples described above may be combined. For example, the user may select the quiet operation preference in the user interface 122. When the temperature management control 104 detects that the internal temperature threshold will be breached, the temperature management control 104 may cause a list of the applications 108 currently operating and the associated amounts of power consumption to be displayed to the user. The temperature management control 104 may suggest some of the applications 108 to suspend or throttle to modify operation of the processor 102 and/or devices 110, 112, 114, and 116 based on the quiet operation preference. The user may then select some of the applications 108 to suspend or throttle from the list. As a result, the temperature management control 104 may avoid accidentally halting an application or device that the user may be using.

As noted above, the temperature management control 104 may continuously monitor the power level and determine whether the internal temperature threshold will be breached or exceeded. After operation of the selected devices is modified, the temperature management control 104 may calculate the power level and temperature increase rate. If the temperature increase rate is below a threshold, then the operation of the applications and the related devices that were selected may be resumed or moved back to the higher operation state before the modification was performed (e.g., the suspended or throttled applications may be resumed at the higher state, resulting in an increase of related disk activity, and so forth).

Thus, the temperature management control 104 may provide more gradual temperature control for the apparatus 100. More gradual temperature control may provide for a better user experience, as sudden activation of the fan, sudden freezing or closing of applications, and the like may be avoided due to overheating of the apparatus 100 during operation.

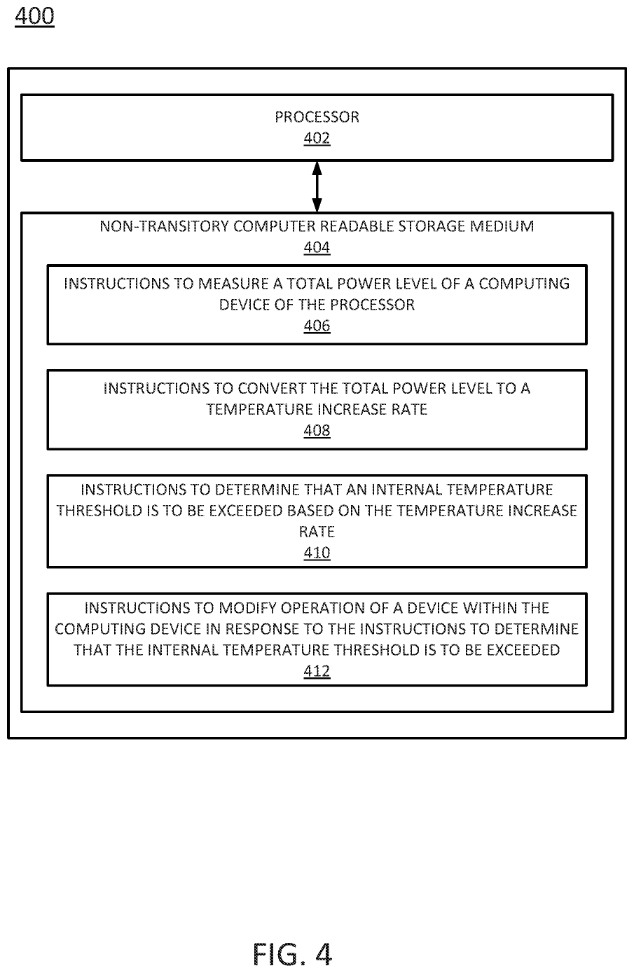

FIG. 4 illustrates an example of an apparatus 400. In one example, the apparatus 400 may be the apparatus 100. In one example, the apparatus 400 may include a processor 402 and a non-transitory computer readable storage medium 404. The non-transitory computer readable storage medium 404 may include instructions 406, 408, 410, and 412, that, when executed by the processor 402, cause the processor 402 to perform various functions.

In one example, the instructions 406 may include instructions to measure a power level of a computing device. In one example, the power level may be based on a power monitor that monitors the overall power consumption of the apparatus. In one example, the power level may be based on a power monitor that monitors the power consumption of each peripheral device and application and totals the amount of power being consumed.

The instructions 408 may include instructions to convert the power level to a temperature increase rate. For example, the power level to temperature increase rate correlation 208 illustrated by the graph 300 may be used to convert the power level to the temperature increase rate.

The instructions 410 may include instructions to determine that an internal temperature threshold is to be exceeded based on the temperature increase rate. For example, whether the internal temperature threshold will be exceeded can be determined based on the temperature increase rate and the current internal temperature.

The instructions 412 may include instructions to modify operation of a device within the computing device in response to the instructions to determine that the internal temperature threshold is to be exceeded. For example, operation of a device may be modified in response to selecting an application to be throttled or suspended. Each application may be associated with various devices associated with the application. For example, a video game application may use large amounts of processor resources, activate the graphical processing unit, use the hard disk drive, and so forth. Thus, the application may be associated with large amounts of power consumption. The application may be suspended or throttled to deactivate, or reduce, some of the activities of the devices associated with the application, and thereby reduce the amount of power consumed by the application. Reducing the amount of power may help to lower the internal temperature of the computing device.

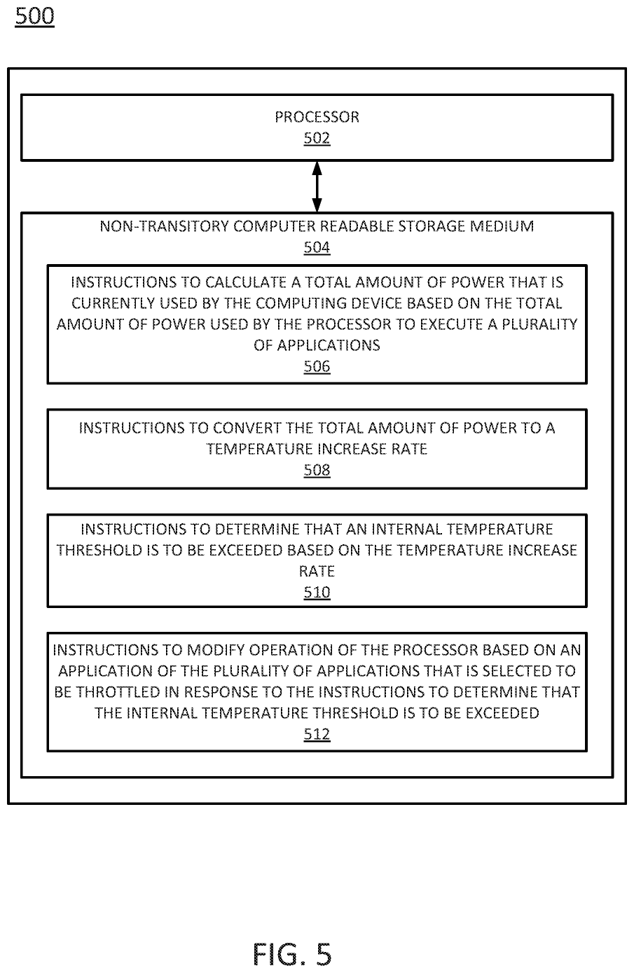

FIG. 5 illustrates an example of an apparatus 500. In one example, the apparatus 500 may be the apparatus 100. In one example, the apparatus 500 may include a processor 502 and a non-transitory computer readable storage medium 504. The non-transitory computer readable storage medium 504 may include instructions 506, 508, 510, and 512, that, when executed by the processor 502, cause the processor 502 to perform various functions.

In one example, the instructions 506 may include instructions to calculate an amount of power that is currently used by the computing device based on the amount of power used by the processor to execute a plurality of applications. For example, each application may consume an amount of processing resources. The more processing resources an application consumes, the harder the processor may have to work, thereby generating more heat. The amount of processing resources used by each application may be proportional to or associated with an amount of power consumption. The amount of power may be calculated by totaling the power consumption associated with the processing resources used by each application.

The instructions 508 may include instructions to convert the amount of power to a temperature increase rate. For example, the power level to temperature increase rate correlation 208 illustrated by the graph 300 may be used to convert the total power level to the temperature increase rate.

The instructions 510 may include instructions to determine that an internal temperature threshold is to be exceeded based on the temperature increase rate. For example, whether the internal temperature threshold will be exceeded can be determined based on the temperature increase rate and the current internal temperature.

The instructions 512 may include instructions to modify operation of the processor by throttling an application of the plurality of applications in response to a determination that the internal temperature threshold is to be exceeded. In one example, the modification of the processor may be to reduce allocated processor resources to certain applications. Reducing the allocation of processor resources to certain applications may slow down or throttle the applications. Since less processing resources are being used, the amount of power consumed by the processor may be reduced, thereby, gradually reducing the internal temperature.

In one example, a list may be provided to the user that includes the amount of processing resources consumed by each application and the corresponding amount of power. As a result, the user may select to suspend or throttle an application with the highest processor usage, reduce the amount of power consumed, and gradually lower the internal temperature.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a power monitor to measure a power level of the apparatus;
a memory to store a power level to temperature increase rate correlation; and
a processor in communication with the power monitor and the memory, wherein the processor is to:
determine that an internal temperature threshold is to be exceeded based on the power level and the power level to temperature increase rate correlation; and
perform a device operation modification to reduce the power level in response to a determination that the internal temperature threshold is to be exceeded.

2. The apparatus of claim 1, further comprising:
a temperature monitor to measure an internal temperature of the apparatus.

3. The apparatus of claim 1, further comprising:
a user interface to receive a selection of a temperature control management preference.

4. The apparatus of claim 3, wherein the temperature control management preference comprises an efficient operation preference or a quiet operation preference.

5. The apparatus of claim 1, wherein the device operation modification is performed in response to throttling or suspending an application executed by the processor.

6. The apparatus of claim 5, wherein the device operation modification comprises reducing or halting activities of a device of the apparatus associated with the application that is throttled or suspended.

7. A non-transitory computer readable storage medium encoded with instructions executable by a processor of a computing device, the non-transitory computer-readable storage medium comprising:
instructions to measure a power level of the computing device;
instructions to convert the power level to a temperature increase rate;
instructions to determine that an internal temperature threshold is to be exceeded based on the temperature increase rate; and
instructions to modify operation of a device within the computing device in response to the instructions to determine that the internal temperature threshold is to be exceeded.

8. The non-transitory computer readable storage medium of claim 7, wherein the instructions measure the power level comprises:
instructions to identify activated devices associated with each one of a plurality of applications; and
instructions to calculate an amount of power of the activated devices for each one of the plurality of applications.

9. The non-transitory computer readable storage medium of claim 7, wherein the instructions to modify operation of the device comprises instructions to throttle an application executed by the processor.

10. The non-transitory computer readable storage medium of claim 9, wherein the application is based on a priority of the application defined by a user defined priority list of applications.

11. The non-transitory computer readable storage medium of claim 9, wherein the application is based on an amount of processor resources consumed by the application.

12. The non-transitory computer readable storage medium of claim 9, wherein the application is selected from a user interface that presents a list of applications and associated information of each of the applications.

13. A non-transitory computer readable storage medium encoded with instructions executable by a processor of a computing device, the non-transitory computer-readable storage medium comprising:
instructions to calculate an amount of power that is currently used by the computing device based on the amount of power used by the processor to execute a plurality of applications;
instructions to convert the amount of power to a temperature increase rate;
instructions to determine that an internal temperature threshold is to be exceeded based on the temperature increase rate; and
instructions to modify operation of the processor by throttling an application of the plurality of applications in response to a determination that the internal temperature threshold is to be exceeded.

14. The non-transitory computer readable storage medium of claim 13, wherein the instructions to modify operation comprises:
instructions to select the application that consumes a highest amount of processor usage.

15. The non-transitory computer readable storage medium of claim 14, wherein throttling the application comprises:
instructions to reduce an amount of processor resources assigned to the application.
